(19) United States
(12) Patent Application Publication
(10) Pub. No.: US 2024/0062384 A1
(43) Pub. Date: Feb. 22, 2024

(54) OBJECT TRACKING METHOD AND HOST

(71) Applicant: HTC Corporation, Taoyuan City (TW)

(72) Inventors: Wen-Shan Yang, Taoyuan City (TW); Tzu-Yin Chang, Taoyuan City (TW)

(73) Assignee: HTC Corporation, Taoyuan City (TW)

(21) Appl. No.: 18/449,711

(22) Filed: Aug. 15, 2023

Related U.S. Application Data
(60) Provisional application No. 63/398,523, filed on Aug. 16, 2022.

(51) Int. Cl. G06T 7/20; G06T 7/70; G06T 7/80

(52) U.S. Cl. CPC G06T 7/20; G06T 7/70; G06T 7/80

(57) ABSTRACT

The embodiments of the disclosure provide an object tracking method and a host. The method includes: determining a reference motion state based on a first predicted motion state and a calibration factor; obtaining a first motion data of the host and a second motion data of a reference object; determining a first relative pose of the reference object relative to the host based on the first motion data, the second motion data, and the reference motion state; and determining a specific pose of the reference object based on the first relative pose.

### CROSS-REFERENCE TO RELATED APPLICATION

This application claims the priority benefit of U.S. provisional application Ser. No. 63/398,523, filed on Aug. 16, 2022. The entirety of the above-mentioned patent application is hereby incorporated by reference herein and made a part of this specification.

### BACKGROUND

### 1. Field of the Invention

The present disclosure generally relates to a tracking mechanism, in particular, to an object tracking method and a host.

### 2. Description of Related Art

See FIG. 1, which shows a conventional mechanism for tracking a reference object. In FIG. 1, a host (e.g., a head-mounted display (HMD)) may track the pose of the reference object (e.g., a handheld VR controller) by using, for example, the inside-out tracking mechanism, and the obtained pose may be referred to a visual relative pose ^{visual}Pose_{B}^{C}. However, the quality of the visual relative pose ^{visual}Pose_{B}^{C} may be affected by problems such as jitter, delay, and/or lost tracking. Therefore, motion data collected by inertial measurement units (IMU) on the reference object may be used to determine the relative pose Pose_{B}^{C} of the reference object relative to the environment, and the relative pose Pose_{B}^{C} can be fused with the visual relative pose ^{visual}Pose_{B}^{C} based on the host pose of the host for improving the tracking performance, wherein the host pose may be determined by the host via using simultaneous localization and mapping (SLAM).

In general, the motion data (e.g., IMU data) is used to characterize the relative pose of the IMU relative to the world and/or the environment. For example, in FIG. 1, the relative pose Pose_{C}^{G} may be the relative pose the host relative to a reference point (which may be the origin of the coordinate system G of the environment. The relative pose Pose_{G}^{W} may be the relative pose of the reference point relative to the world (which corresponds to the coordinate system W).

To better fuse the relative pose Pose_{B}^{C} with the visual relative pose ^{visual}Pose_{B}^{C}, the relative poses Pose_{C}^{G} and Pose_{G}^{W} need to be taken into consideration. However, in the conventional art, the relative pose Pose_{B}^{C} can be better fused with the visual relative pose ^{visual}Pose_{B}^{C} only if the relative pose Pose_{G}^{W} stays constant. That is, if the relative pose Pose_{G}^{W} is varying, the relative pose Pose_{B}^{C} cannot be accurately fused with the visual relative pose ^{visual}Pose_{B}^{C}, such that the pose of the reference object would not be accurately tracked.

For example, if the host and the reference object are in a car (i.e., the environment where the host and the reference object locate), and the reference point is a particular point on the car, the coordinate system G can be assumed to be the coordinate system used within the car, and the coordinate system W can be assumed to be the coordinate system corresponding to the environment outside of the car (which can be understood as the coordinate system of the world).

In a case where the car is static, since relative pose Pose_{G}^{W} is constant, the relative pose Pose_{B}^{C} can be accurately fused with the visual relative pose ^{visual}Pose_{B}^{C}. However, in a case where the car is moving, since relative pose Pose_{G}^{W} is varying, the relative pose Pose_{B}^{C} cannot be properly fused with the visual relative pose ^{visual}Pose_{B}^{C}, such that the pose of the reference object would not be accurately tracked.

In addition, if the host and the reference object are in an environment with few feature points (e.g., the environment with white walls), since the translation component in of the host pose are almost unavailable, the relative pose Pose_{B}^{C} cannot be properly fused with the visual relative pose ^{visual}Pose_{B}^{C} as well.

### SUMMARY OF THE INVENTION

Accordingly, the disclosure is directed to an object tracking method and a host, which may be used to solve the above technical problems.

The embodiments of the disclosure provide an object tracking method, adapted to a host, comprising: determining a reference motion state based on a first predicted motion state and a calibration factor; obtaining a first motion data of the host and a second motion data of a reference object; determining a first relative pose of the reference object relative to the host based on the first motion data, the second motion data, and the reference motion state; and determining a specific pose of the reference object based on the first relative pose.

The embodiments of the disclosure provide a host, comprising a non-transitory storage circuit and a processor. The non-transitory storage circuit stores a program code. The processor is coupled to the non-transitory storage circuit and accesses the program code to perform: determining a reference motion state based on a first predicted motion state and a calibration factor; obtaining a first motion data of the host and a second motion data of a reference object; determining a first relative pose of the reference object relative to the host based on the first motion data, the second motion data, and the reference motion state; and determining a specific pose of the reference object based on the first relative pose.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a conventional mechanism for tracking a reference object.

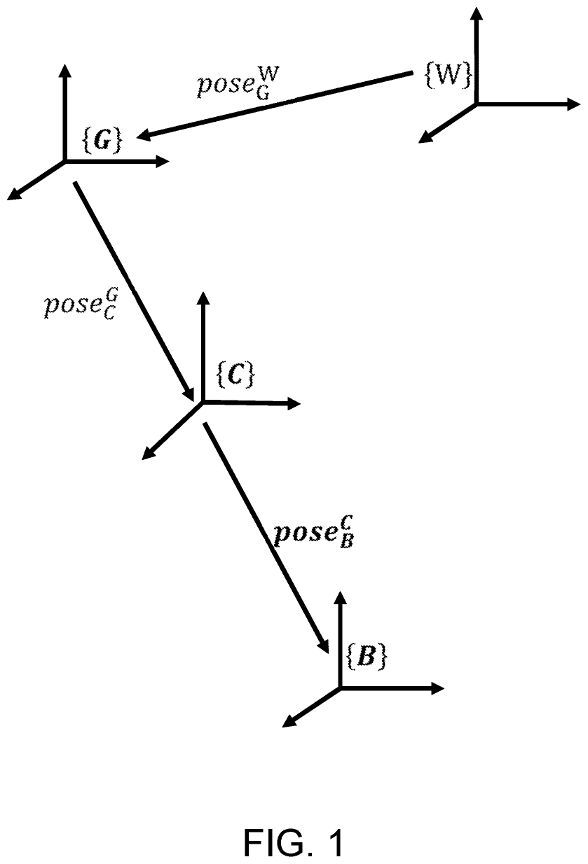

FIG. 2 shows a schematic diagram of a host according to an embodiment of the disclosure.

FIG. 3 shows a schematic diagram of the iterative process of the proposed method according to an embodiment of the disclosure.

FIG. 4 shows an application scenario according to an embodiment of the disclosure.

FIG. 5 shows a flow chart of the object tracking method according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

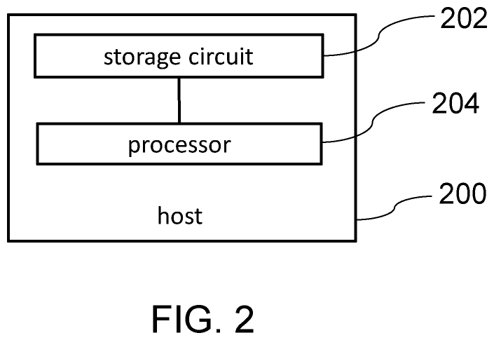

See FIG. 2, which shows a schematic diagram of a host according to an embodiment of the disclosure. In FIG. 2, the host 200 can be any device capable of tracking the pose of other to-be-tracked objects (e.g., handheld controllers) via performing inside-out tracking mechanisms, but the disclosure is not limited thereto. In some embodiment, the host 200 can be the HMD that provides AR/VR services/contents or the like.

In FIG. 2, the host 200 includes a storage circuit 202 and a processor 204. The storage circuit 202 is one or a combination of a stationary or mobile random access memory (RAM), read-only memory (ROM), flash memory, hard disk, or any other similar device, and which records a plurality of modules that can be executed by the processor 204.

The processor 204 may be coupled with the storage circuit 202, and the processor 204 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 204 may access the modules

stored in the storage circuit 202 to implement the object tracking method provided in the disclosure, which would be further discussed in the following.

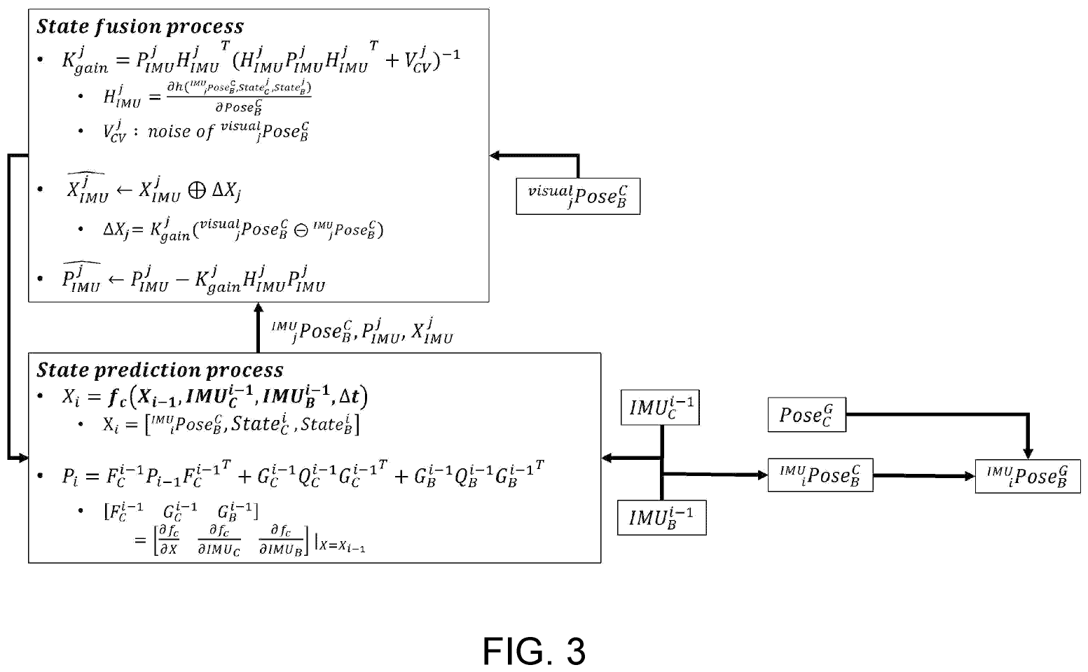

See FIG. 3, which shows a schematic diagram of the iterative process of the proposed method according to an embodiment of the disclosure.

In FIG. 3, the iterative process can be regarded as including two sub-processes: (1) the state fusion process; and (2) the state prediction process.

In one embodiment, the processor 204 determines a reference motion state (referred to as [symbol] , wherein j is a stage index associated with the state fusion process) based on a predicted motion state (referred to as X_{IMU}^{j}) and a calibration factor (referred to as ΔXⱼ), which can be referred to the lower part of the state fusion process. In one embodiment, the reference motion state [symbol] can be determined by combining the predicted motion state X_{IMU}^{j} with the calibration factor ΔXⱼ, and the reference motion state [symbol] can be characterized as “ [symbol] ←X_{IMU}^{j}⊕ΔXⱼ” in FIG. 3. In one embodiment, how the predicted motion state X_{IMU}^{j} is determined would be explained in the discussions associated with the state prediction process.

In one embodiment, in the procedure of determining the calibration factor ΔXⱼ, the processor 204 obtain a specific gain (referred to as K_{gain}^{j}), the visual relative pose (i.e., ^{visual}ⱼPose_{B}^{C} mentioned in the above) of the reference object relative to the host 200 and a motion relative pose (referred to as ^{IMU}ⱼPose_{B}^{C}) of the reference object relative to the host 200. Afterwards, the processor 204 determines the calibration factor ΔXⱼ based on the specific gain K_{gain}^{j}, the visual relative pose ^{visual}ⱼPose_{B}^{C}, and the motion relative pose ^{IMU}ⱼPose_{B}^{C}.

In the embodiments of the disclosure, the specific gain K_{gain}^{j} can be understood as a Kalman gain, which can be determined based on some parameters determined in the state prediction process (which would be discussed later). The visual relative pose ^{visual}ⱼPose_{B}^{C} can be the tracked visual pose of the reference object relative to the host 200, which can be determined by the processor 204 via performing the inside-out tracking mechanism. The motion relative pose ^{IMU}ⱼPose_{B}^{C} can be determined by the processor 204 based on the first motion data collected by a first motion detection circuit (e.g., IMU) on the host 200 and the second motion data collected by a second motion detection circuit (e.g., IMU) on the reference object, and how the motion relative pose ^{IMU}ⱼPose_{B}^{C} is determined would be explained in the following discussions associated with the state prediction process.

In the procedure of determining the calibration factor ΔXⱼ, the processor 204 can firstly determine a pose difference between the visual relative pose ^{visual}ⱼPose_{B}^{C} and the motion relative pose ^{IMU}ⱼPose_{B}^{C}, wherein the pose difference can be represented as “^{visual}ⱼPose_{B}^{C}⊖^{IMU}ⱼPose_{B}^{C}”. Next, the processor 204 can determine the calibration factor ΔXⱼ based on the specific gain K_{gain}^{j} and the pose difference via, for example, multiplying the pose difference by the specific gain K_{gain}^{j}. In this case, the calibration factor ΔXⱼ can be characterized as “ΔXⱼ=K_{gain}^{j}(^{visual}ⱼPose_{B}^{C}⊖^{IMU}ⱼPose_{B}^{C})” as exemplarily shown in the state fusion process of FIG. 3, but the disclosure is not limited thereto.

In the embodiments of the disclosure, the reference motion state [symbol] can be used to determine a next predicted motion state in the state prediction process.

In the embodiments of the disclosure, the stage indexes used in the state fusion process and the state prediction process can be different. In FIG. 3, the stage index used in the state prediction process can be i, and the reference motion state [symbol] (which can be understood as the reference motion state determined at j-th stage of the state fusion process) can correspond to the predicted motion state (referred to as Xᵢ) determined at the i-th stage of the state prediction process.

In this case, the above-mentioned next predicted motion state may be understood as the predicted motion state determined at the (i+1)-th stage of the state prediction process (referred to as Xᵢ₊₁), and the predicted motion state Xᵢ₊₁ can be determined based on the predicted motion state Xᵢ, the first motion data, and the second motion data.

However, instead of explaining the details of determining the predicted motion state Xᵢ₊₁, how the predicted motion state X_{IMU}^{j} (i.e., the predicted motion state Xᵢ) is determined would be used as an illustrative example for better understanding the concept of the disclosure.

In FIG. 3, the first motion data and the second motion data used to determine the predicted motion state Xᵢ can be referred to as IMU_{C}ⁱ⁻¹ and IMU_{B}ⁱ⁻¹, respectively. In some embodiments, the first motion data IMU_{C}ⁱ⁻¹ may include raw IMU data (e.g., 3-axis accelerations and 3-axis angular velocities) collected at the (i−1)-th stage of the state prediction process by the first motion detection circuit on the host 200, and the second motion data IMU_{B}ⁱ⁻¹ may include raw IMU data (e.g., 3-axis accelerations and 3-axis angular velocities) collected at the (i−1)-th stage of the state prediction process by the second motion detection circuit on the reference object.

In the embodiments of the disclosure, the processor 204 can determine the predicted motion state Xᵢ based on the first motion data IMU_{C}ⁱ⁻¹, the second motion data IMU_{B}ⁱ⁻¹, and a reference motion state [symbol] (which can be understood as the predicted motion state Xᵢ₋₁).

In one embodiment, the processor 204 may determine a dynamic function (referred to as ƒ_{c}) used in the coordinate system C, wherein the dynamic function ƒ_{c} may consider the reference motion state [symbol] (i.e., the predicted motion state Xᵢ₋₁), the first motion data IMU_{C}ⁱ⁻¹, the second motion data IMU_{B}ⁱ⁻¹, and the time difference (referred to as Δt) between i-th stage of the state prediction process and the (i−1)-th stage of the state prediction process.

In FIG. 3, the predicted motion state Xᵢ can be characterized as “Xᵢ=ƒ_{c}(Xᵢ₋₁,IMU_{C}ⁱ⁻¹,IMU_{B}ⁱ⁻¹,Δt)”. In one embodiment, the dynamic function can output/generate/determine a first relative pose and parameters associated with the first motion data and the second motion data in response to the reference motion state [symbol] , the first motion data IMU_{C}ⁱ⁻¹, the second motion data IMU_{B}ⁱ⁻¹, and the time difference Δt. That is, the predicted motion state Xᵢ can include the first relative pose and parameters associated with the first motion data and the second motion data.

In the embodiments of the disclosure, the first relative pose can be represented by ^{IMU}ᵢPose_{B}^{C}, which can be understood as an i-th motion relative pose of the reference object relative to the host 200 at the i-th stage of the state prediction process. In some embodiments, the first relative pose can be characterized as “^{IMU}ᵢPose_{B}^{C}=[T_{B}_{ᵢ}^{C}^{ᵢ} q_{B}_{ᵢ}^{C}^{ᵢ} V_{B}_{ᵢ}^{C}^{ᵢ} W_{B}_{ᵢ}^{C}^{ᵢ}]”, wherein T_{B}_{ᵢ}^{C}^{ᵢ}, q_{B}_{ᵢ}^{C}^{ᵢ}, V_{B}_{ᵢ}^{C}^{ᵢ}, W_{B}_{ᵢ}^{C}^{ᵢ} respectively corresponds to translation, orientation, velocity, and angular velocity of the reference object relative to the host 200 at i-th stage of the state prediction process, but the disclosure is not limited thereto.

In one embodiment, the i-th motion relative pose (i.e., ^{IMU}ᵢPose_{B}^{C}) can be used to determine the calibration factor for the j-th stage of the state fusion process, and the details of determining the calibration factor for the j-th stage of the state fusion process can be referred to the above descriptions, which would not be repeated herein.

In one embodiment, the parameters associated with the first motion data include intrinsic and extrinsic parameters associated with the first motion detection circuit at the i-th stage of the state prediction process, which can be referred to as State_{C}ⁱ. The parameters associated with the second motion data include intrinsic and extrinsic parameters associated with the second motion detection circuit at the i-th stage of the state prediction process, which can be referred to as State_{B}ⁱ.

Accordingly, the second predicted motion state Xᵢ can be further characterized as “Xᵢ=[^{IMU}ᵢPose_{B}^{C},State_{C}ⁱ,State_{B}ⁱ]” as shown in FIG. 3.

In one embodiment, the contents in the predicted motion state Xᵢ can be used to determine the specific gain K_{gain}^{j} (e.g., the Kalman gain) for the j-th stage of the state fusion process.

In one embodiment, during determining the specific gain K_{gain}^{j}, the processor 204 may obtain a first reference gain factor (referred to as P_{IMU}^{j}), the predicted motion state X_{IMU}^{j} (which can be characterized by [^{IMU}ⱼPose_{B}^{C},State_{C}^{j},State_{B}^{j}] based on the above teachings), and the visual relative pose ^{visual}ⱼPose_{B}^{C}, and accordingly determine the specific gain K_{gain}^{j}.

At the j-stage of the state fusion process in FIG. 3, the specific gain K_{gain}^{j} can be characterized as “K_{gain}^{j}=P_{IMU}^{j}H_{IMU}^{j}^{^{T}}(H_{IMU}^{j}P_{IMU}^{j}H_{IMU}^{j}^{^{T}}+V_{CV}^{j})⁻¹”, wherein

$${H}_{IMU}^{j} = \frac{\partial h ( {}_{j}^{IMU} {Pose}_{B}^{C} , {State}_{C}^{j} , {State}_{B}^{j} )}{\partial Po {se}_{B}^{C}}$$

(which can be understood as taking partial derivatives on the contents of the first predicted motion state X_{IMU}^{j}) and V_{CV}^{j} is the noise of the visual relative pose ^{visual}ⱼPose_{B}^{C}, but the disclosure is not limited thereto.

In one embodiment, the reference gain factor P_{IMU}^{j} can be updated based on the specific gain K_{gain}^{j} and the predicted motion state X_{IMU}^{j}. In FIG. 3, the updated reference gain factor (referred to as [symbol] ) can be characterized as “ [symbol] ←P_{IMU}^{j}−K_{gain}^{j}H_{IMU}^{j}P_{IMU}^{j}”, but the disclosure is not limited thereto.

In one embodiment, the updated reference gain factor [symbol] can be used to determine a new reference gain factor at the next stage (i.e., the (i+1)-th stage) of the state prediction process.

However, for better understanding the concept of the disclosure, the mechanism for determining the reference gain factor P_{IMU}^{j} would be used as an example, but the disclosure is not limited thereto.

In one embodiment, the reference gain factor P_{IMU}^{j} used at the j-th stage of the state fusion process may correspond (or be mapped) to another reference gain factor determined at the i-th stage of the state prediction process, which can be referred to as Pᵢ.

Specifically, in the procedure of determining the reference gain factor Pᵢ, the processor 204 may obtain an updated reference gain factor (referred to as Pᵢ₋₁) and the predicted motion state Xᵢ, wherein the updated reference gain factor Pᵢ₋₁ can be understood as the reference gain factor updated in the previous stage of the state fusion process.

In one embodiment, the processor 204 determines the reference gain factor Pᵢ based on the updated reference gain factor Pᵢ₋₁ and the predicted motion state Xᵢ. In FIG. 3, the reference gain factor Pᵢ can be characterized as “Pᵢ=F_{C}ⁱ⁻¹Pᵢ₋₁F_{C}ⁱ⁻¹^{^{T}}+G_{C}ⁱ⁻¹Q_{C}ⁱ⁻¹G_{C}ⁱ⁻¹^{^{T}}+G_{B}ⁱ⁻¹Q_{B}ⁱ⁻¹G_{B}ⁱ⁻¹^{^{T}}”, wherein

$$[ {F}_{C}^{i - 1} {G}_{C}^{i - 1} {G}_{B}^{i - 1} ] = [ \frac{\partial {f}_{c}}{\partial X} \frac{\partial {f}_{c}}{\partial {IMU}_{C}} \frac{\partial {f}_{c}}{\partial {IMU}_{B}} ] {\vert}_{X = {X}_{i - 1}} ,$$

Q_{C}ⁱ⁻¹ is the noise of the first motion data IMU_{C}ⁱ⁻¹, and Q_{B}ⁱ⁻¹ is the noise of the second motion data IMU_{B}ⁱ⁻¹, but the disclosure is not limited thereto.

Once the reference gain factor Pᵢ is determined, the reference gain factor Pᵢ can be used as the reference gain factor P_{IMU}^{j} at the j-th stage of the state fusion process for determining, for example, the specific gain K_{gain}^{j}, and the associated details can be referred to the above teachings.

In brief, the predicted motion state Xᵢ, the first relative pose ^{IMU}ᵢPose_{B}^{C}, and the reference gain factor Pᵢ determined at the i-stage of the state prediction process can be respectively used as the predicted motion state X_{IMU}^{j}, the motion relative pose ^{IMU}ⱼPose_{B}^{C}, and the reference gain factor P_{IMU}^{j}, and the predicted motion state X_{IMU}^{j}, the motion relative pose ^{IMU}ⱼPose_{B}^{C}, and the reference gain factor P_{IMU}^{j} can be used to determine the specific gain K_{gain}^{j}, the predicted motion state [symbol] and the reference gain factor [symbol] at the j-th stage of the state fusion process.

Once the predicted motion state [symbol] and the reference gain factor [symbol] are determined, the predicted motion state [symbol] and the reference gain factor [symbol] can be further used to determine the predicted motion state Xᵢ₊₁ and the reference gain factor Pᵢ₊₁ at the (i+1)-stage of the state prediction process. Accordingly, the processor 204 can continuously perform the iterative process in FIG. 3 for determining the parameters/factors shown in FIG. 3 at different stages of the state fusion process and/or the state prediction process.

In one embodiment, the processor 204 can determine a specific pose (referred to as ^{IMU}ᵢPose_{B}^{G}) of the reference object based on the first relative pose ^{IMU}ᵢPose_{B}^{C}.

In one embodiment, the processor 204 obtains a specific relative pose (e.g., the relative pose Pose_{C}^{G} mentioned in the above) of the host 200 relative to a reference coordinate system (e.g., the coordinate system G mentioned in the above) and determines the specific pose ^{IMU}ᵢPose_{B}^{G} of the reference object via combining the specific relative pose Pose_{C}^{G} with the first relative pose ^{IMU}ᵢPose_{B}^{C}. The details of combining the specific relative pose Pose_{C}^{G} with the first relative pose ^{IMU}ᵢPose_{B}^{C} can be referred to the associated prior art, which would not be further discussed herein.

In the embodiments of the disclosure, since the first motion data associated with the host 200 is considered in the procedure for determining the first relative pose ^{IMU}ᵢPose_{B}^{C} in the state prediction process, the first relative pose ^{IMU}ᵢPose_{B}^{C} can be better fused with the visual relative pose ^{visual}ⱼPose_{B}^{C} at the state fusion process for determining the reference motion state [symbol] . Afterwards, the reference motion state [symbol] can be used to determine the first relative pose corresponding to the next stage of the state prediction process, and so on. In this case, the pose of the reference object can be determined without considering the relative pose Pose_{G}^{W}.

Therefore, in scenarios with varying relative pose Pose_{G}^{W} and/or environments with few feature points, the pose of the reference object can still be properly determined. In addition, since the proposed method can be performed without considering the relative pose Pose_{G}^{W}, the proposed method can be used to determine the pose of the reference object in the environments with no gravity.

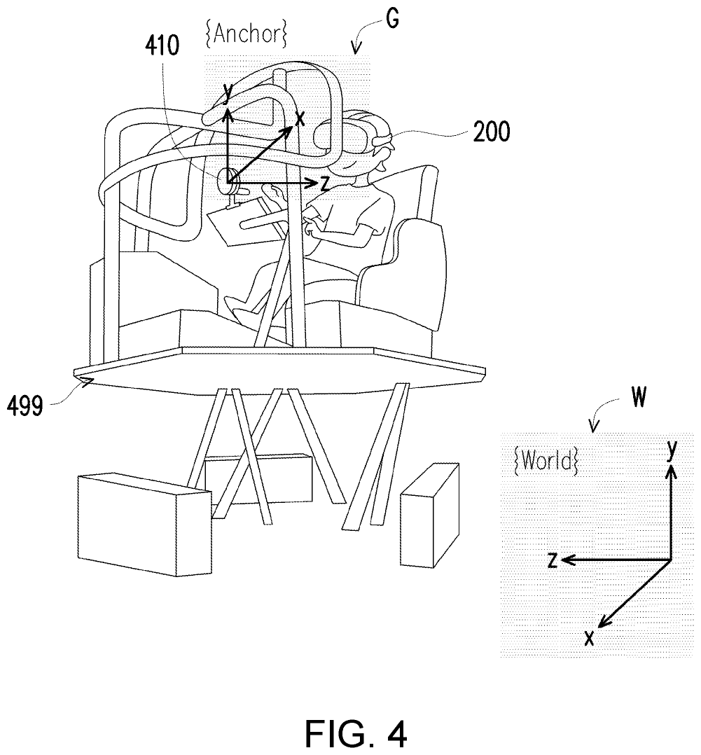

See FIG. 4, which shows an application scenario according to an embodiment of the disclosure. In FIG. 4, the host 200 may be an HMD worn by the user on the simulator 499, the to-be-tracked reference object 410 can be the handheld controller connected with the HMD, and the HMD may be used to provide, for example, VR services to the user.

In the embodiment, the coordinate system G can be the coordinate system of the simulator 499, and the relative pose Pose_{G}^{W} between the coordinate systems G and W would be varying since the simulator 499 would move in response to the user's operations to the VR services provided by the HMD. In this case, the proposed method can still properly work to accurately determine the pose of the reference object 410 even if the relative pose Pose_{G}^{W} is varying.

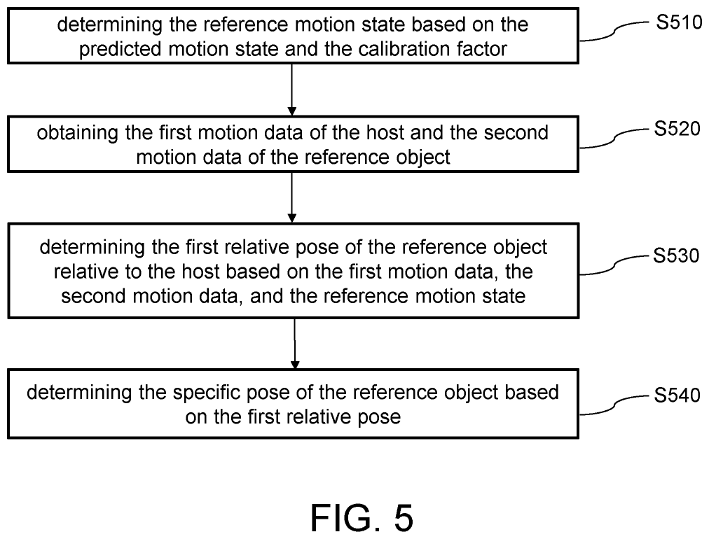

See FIG. 5, which shows a flow chart of the object tracking method according to an embodiment of the disclosure. The method of this embodiment may be executed by the host 200 in FIG. 2, and the details of each step in FIG. 5 will be described below with the components shown in FIG. 2.

In step S510, the processor 204 determining the reference motion state (e.g., [symbol] ) based on the predicted motion state (e.g., X_{IMU}^{j}) and the calibration factor (e.g., ΔXⱼ). In step S520, the processor 204 obtains the first motion data (e.g., IMU_{C}ⁱ) of the host 200 and the second motion data (e.g., IMU_{B}ⁱ) of the reference object. In step S530, the processor 204 determine the first relative pose (e.g., ^{IMU}ᵢ₊₁Pose_{B}^{C}) of the reference object relative to the host 200 based on the first motion data, the second motion data, and the reference motion state. In step S540, the processor 204 determines the specific pose (e.g., ^{IMU}ᵢ₊₁Pose_{B}^{G}) of the reference object based on the first relative pose.

Details of the steps in FIG. 5 can be referred to the descriptions in the above embodiments, which would not be repeated herein.

To sum up, by considering the motion data associated with the movement of the host, the embodiments of the disclosure provide a solution to properly determine the pose of the to-be-tracked reference object even if the relative pose of the environment relative to the world is varying. Accordingly, the pose of the reference object can be tracked in a novel, flexible, and accurate way.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. An object tracking method, adapted to a host, comprising:
determining a reference motion state based on a first predicted motion state and a calibration factor;
obtaining a first motion data of the host and a second motion data of a reference object;
determining a first relative pose of the reference object relative to the host based on the first motion data, the second motion data, and the reference motion state; and
determining a specific pose of the reference object based on the first relative pose.

2. The method according to claim 1, further comprising:
obtaining a specific gain, a visual relative pose of the reference object relative to the host and a motion relative pose of the reference object relative to the host;
determining the calibration factor based on the specific gain, the visual relative pose, and the motion relative pose.

3. The method according to claim 2, further comprising:
obtaining a first reference gain factor, the first predicted motion state, and the visual relative pose, and accordingly determining the specific gain.

4. The method according to claim 3, further comprising:
updating the first reference gain factor based on the specific gain and the first predicted motion state.

5. The method according to claim 2, wherein the step of determining the calibration factor based on the specific gain, the visual relative pose, and the motion relative pose comprises:
determining a pose difference between the visual relative pose and the motion relative pose; and
determining the calibration factor based on the specific gain and the pose difference.

6. The method according to claim 1, wherein the step of determining the reference motion state based on the first predicted motion state and the calibration factor comprises:
determining the reference motion state via combining the first predicted motion state with the calibration factor.

7. The method according to claim 1, wherein the step of determining the first relative pose of the reference object relative to the host based on the first motion data, the second motion data, and the reference motion state comprises:
determining a second predicted motion state based on the first motion data, the second motion data, and the reference motion state, wherein the second predicted motion state comprises the first relative pose and parameters associated with the first motion data and the second motion data.

8. The method according to claim 7, wherein the first motion data is collected by a first motion detection circuit on the host, the second motion data is collected by a second motion detection circuit on the reference object;
wherein the parameters associated with the first motion data comprise intrinsic and extrinsic parameters associated with the first motion detection circuit;
wherein the parameters associated with the second motion data comprise intrinsic and extrinsic parameters associated with the second motion detection circuit.

9. The method according to claim 1, further comprising:
obtaining an updated reference gain factor and a second predicted motion state;
determining a second reference gain factor based on the updated reference gain factor and the second predicted motion state.

10. The method according to claim 1, wherein the step of determining the specific pose of the reference object based on the first relative pose comprises:
obtaining a specific relative pose of the host relative to a reference coordinate system;
determining the specific pose of the reference object via combining the specific relative pose with the first relative pose.

11. A host, comprising:
a non-transitory storage circuit, storing a program code; and
a processor, coupled to the non-transitory storage circuit and accessing the program code to perform:
determining a reference motion state based on a first predicted motion state and a calibration factor;
obtaining a first motion data of the host and a second motion data of a reference object;
determining a first relative pose of the reference object relative to the host based on the first motion data, the second motion data, and the reference motion state; and
determining a specific pose of the reference object based on the first relative pose.

12. The host according to claim 11, wherein the processor further performs:
obtaining a specific gain, a visual relative pose of the reference object relative to the host and a motion relative pose of the reference object relative to the host;
determining the calibration factor based on the specific gain, the visual relative pose, and the motion relative pose.

13. The host according to claim 12, wherein the processor further performs:
obtaining a first reference gain factor, the first predicted motion state, and the visual relative pose, and accordingly determining the specific gain.

14. The host according to claim 13, wherein the processor further performs:
updating the first reference gain factor based on the specific gain and the first predicted motion state.

15. The host according to claim 12, wherein the processor performs:
determining a pose difference between the visual relative pose and the motion relative pose; and
determining the calibration factor based on the specific gain and the pose difference.

16. The host according to claim 11, wherein the processor performs
determining the reference motion state via combining the first predicted motion state with the calibration factor.

17. The host according to claim 11, wherein the processor performs:
determining a second predicted motion state based on the first motion data, the second motion data, and the reference motion state, wherein the second predicted motion state comprises the first relative pose and parameters associated with the first motion data and the second motion data.

18. The host according to claim 17, wherein the first motion data is collected by a first motion detection circuit on the host, the second motion data is collected by a second motion detection circuit on the reference object;
wherein the parameters associated with the first motion data comprise intrinsic and extrinsic parameters associated with the first motion detection circuit;
wherein the parameters associated with the second motion data comprise intrinsic and extrinsic parameters associated with the second motion detection circuit.

19. The host according to claim 11, wherein the processor further performs:
obtaining an updated reference gain factor and a second predicted motion state;
determining a second reference gain factor based on the updated reference gain factor and the second predicted motion state.

20. The host according to claim 11, wherein the processor performs:
obtaining a specific relative pose of the host relative to a reference coordinate system;
determining the specific pose of the reference object via combining the specific relative pose with the first relative pose.
